(19) United States
(12) Patent Application Publication
(10) Pub. No.: US 2001/0040075 A1
(43) Pub. Date: Nov. 15, 2001

(54) Method of increasing the length and thickness of graphite flakes in a gray iron brake rotor

(76) Inventors: Anwar R. Daudi, Ann Arbor, MI (US); Weston E. Dickerson, Milford, MI (US)

Correspondence Address: Donald A. Schurr, Marshall & Melhorn, LLC, Eighth Floor, Four SeaGate, Toledo, OH, 43604, US

(21) Appl. No.: 09/752,334

(22) Filed: Dec. 29, 2000

Related U.S. Application Data
(60) Provisional application No. 60/173,814, filed on Dec. 30, 1999.

(51) Int. Cl. F16D 65/10

(52) U.S. Cl. 188/218 XL; 188/18 A

(57) ABSTRACT

A method of increasing the length, thickness, and density of graphite flakes in a brake rotor includes forming a brake rotor of gray iron, cast iron, or damped iron. The method further includes EDG machining a surface of the brake rotor.

### RELATED APPLICATIONS

This application claims the benefit under 35 U.S.C. 119(e) of U.S. Provisional Application No. 60/173,814 filed Dec. 30, 1999 which is hereby incorporated herein by reference.

### BACKGROUND OF INVENTION

The present invention relates to a vehicle brake rotor and more specifically to a method of improving the damping characteristics of a brake rotor by increasing the length and/or thickness of graphite flakes in a gray iron brake rotor.

Wheeled vehicles are typically slowed and stopped with a braking system that generates frictional forces. One known braking system is the disc brake system which includes a rotor attached to one or more of the vehicle wheels for rotation therewith. Rotors typically include a central hat section for attaching the rotor to the vehicle, and an outer friction section having opposite, substantially parallel friction surfaces.

The disc brake assembly further includes a caliper assembly secured to a non-rotating component of the vehicle for moving friction members, such as brake pads, into contact with the rotor friction surfaces. During braking, the brake pads press against the moving rotor friction surfaces creating frictional forces which oppose the rotation of the wheels and slow the vehicle.

Brake rotors are typically cast from a ferrous material, such as gray iron, and are then machined to achieve the desired dimensions and tolerances. During conventional machining, a tool is pressed against the rotor to remove a portion of the surface of the rotor, such as the friction surface.

Unwanted noise and vibrations are often created during braking with conventionally machined rotors. The disc brake system components, such as the caliper and brake pads, vibrate during braking. This vibrational energy is transferred to the rotor which is also known as exciting the rotor. The excited rotor vibrates with the greatest amplitude at or near it's resonant frequencies producing undesirable audible noises such as “squeal”.

It is desirable to improve the damping of the rotor thereby reducing the noise and vibration from the rotor during braking.

### SUMMARY OF INVENTION

The invention relates to a method of increasing the length, thickness, and density of graphite flakes in a brake rotor. A brake rotor is formed of gray iron, cast iron, or damped iron in any suitable conventional manner. A surface of the brake rotor is EDG machined using any suitable EDG machining technique to increase the length, thickness, and density of the graphite flakes found in the microstructure of the rotor. The rotor may be a solid rotor or a ventilated rotor.

### BRIEF DESCRIPTION OF THE DRAWINGS

The advantages of the invention will become readily apparent to those skilled in the art from the following detailed description of a preferred embodiment when considered in the light of the accompanying drawings, in which:

FIG. 1 is a cross sectional elevational view of a solid brake rotor;

FIG. 2 is a cross sectional elevational view of a ventilated brake rotor;

FIG. 3a is an optical micrograph of the microstructure of a conventionally machined rotor between the inboard friction surface to a depth of approximately 200 microns into the friction surface;

FIG. 3b is an optical micrograph of the microstructure of an EDG machined rotor at a similar location as FIG. 3a;

FIG. 3c is an optical micrograph of the microstructure of a conventionally machined rotor a depth of approximately 1 mm into the friction surface;

FIG. 3d is an optical micrograph of the microstructure of an EDG machined rotor at a similar location as FIG. 3c;

FIG. 4a is a scanning electron micrograph taken of a conventionally machined rotor taken along the radially outer edge of the inboard braking plate;

FIG. 4b is a scanning electron micrograph of the microstructure of an EDG machined rotor at a similar location as FIG. 4a;

FIG. 5a is a scanning electron micrograph of the microstructure of a conventionally machined rotor taken approximately midway between the machined inboard friction surface and the inner surface of the inboard braking plate;

FIG. 5b is a scanning electron micrograph of the microstructure of an EDG machined rotor at a similar location as FIG. 5a;

FIG. 6a is a scanning electron micrograph of the microstructure of a conventionally machined rotor taken at the inner surface of the inboard braking plate which faces the outboard braking plate.

FIG. 6b is a scanning electron micrograph of the microstructure of an EDG machined rotor at a similar location as FIG. 6a;

FIG. 7a is an optical micrograph of the microstructure of a conventionally machined solid rotor taken near the friction surface;

FIG. 7b is an optical micrograph of the microstructure of an EDG machined solid rotor at a similar location as FIG. 7a;

FIG. 7c is an optical micrograph of the microstructure of a conventionally machined solid rotor taken at a depth of approximately 0.90 mm into the friction surface;

FIG. 7d is an optical micrograph of the microstructure of an EDG machined solid rotor at a similar location as FIG. 7c;

FIG. 8a is an optical micrograph of the microstructure of an as-cast ventilated rotor taken at the friction surface;

FIG. 8b is an optical micrograph of the microstructure of the as-cast ventilated rotor after being EDG machined taken at a similar location as FIG. 8a;

FIG. 8c is an optical micrograph of the microstructure of an as-cast ventilated rotor taken at a depth of approximately 0.9 mm into the friction surface; and

FIG. 8d is an optical micrograph of the microstructure of the as-cast ventilated rotor after being EDG machined taken at a similar location as FIG. 8c.

### DETAILED DESCRIPTION OF THE INVENTION

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

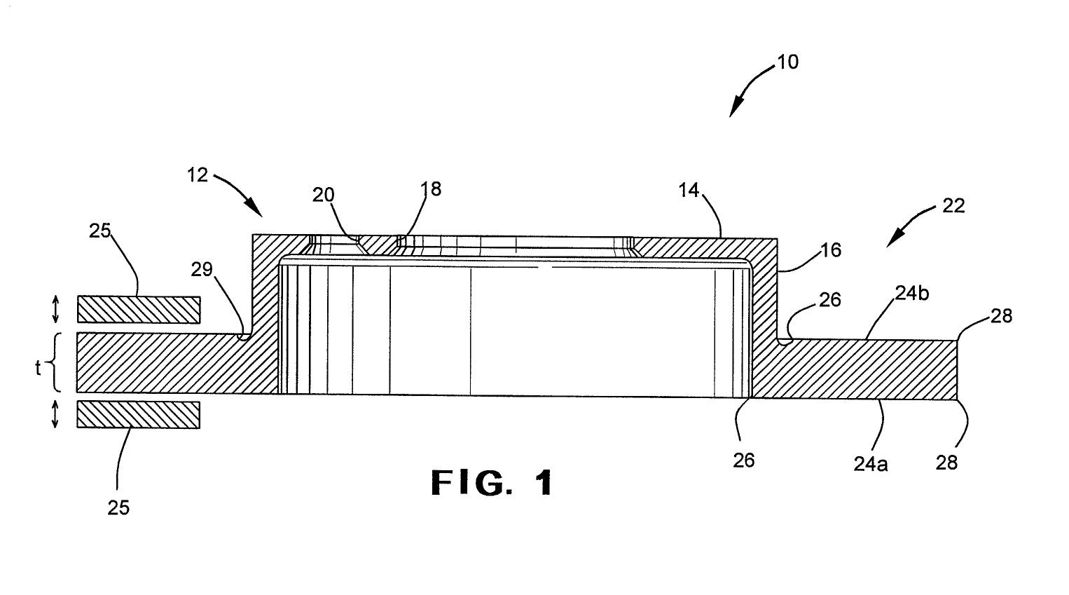

The invention relates to improving the damping characteristics of a disc brake rotor, such as the illustrated generally at 10 in FIG. 1. The rotor 10 includes a radially inner hub portion 12 having a central mounting section 14 for mounting the rotor on an associated drive member (not shown), such as a spindle or vehicle axle. A hat wall 16 extends from the periphery of the mounting section 14. The hat wall 16 may be straight and cylindrical, extending at a right angle from the mounting section 14, or the hat wall or portions of it may be inclined, forming a portion of a cone, or it may be curved. The central mounting section 14 has a central pilot aperture 18, in which the drive member is closely received. Fastener apertures 20 are formed in the central mounting section 14 for receiving fasteners to secure the rotor to the vehicle (not shown).

The rotor 10 also includes a radially outer annular friction section 22 having opposite friction surfaces including an inboard friction surface 24a and an outboard friction surface 24b. The friction surfaces 24a, 24b interface with associated friction members 25, such as brake pads or the like. The annular friction section 22 of the rotor 10 has a radially inner edge 26 and a radially outer edge 28. An annular groove 29 is preferably disposed adjacent the hat wall 16 at the radially inner edge 26 of the friction section 22. The rotor 10 is known as a solid rotor.

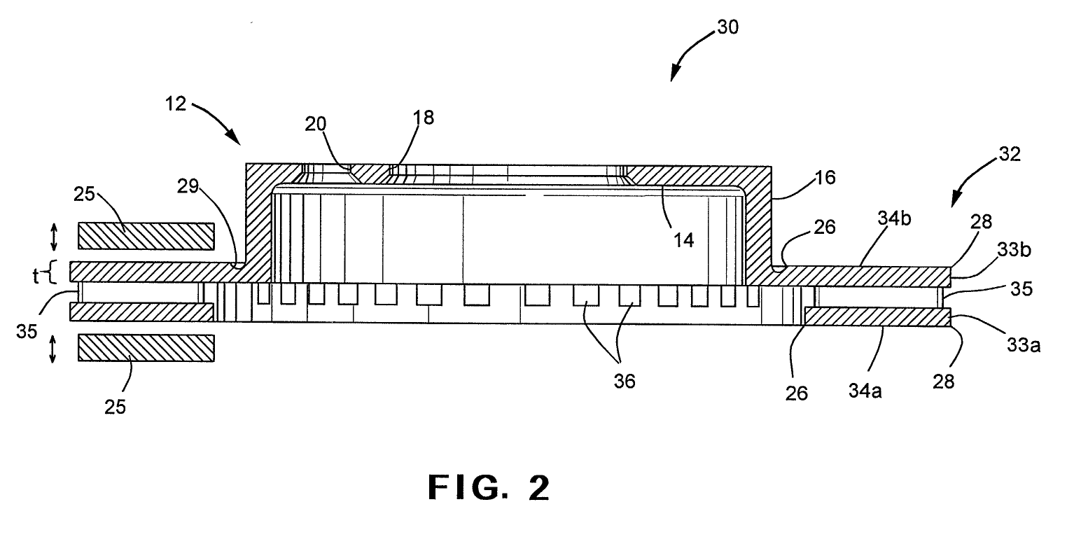

Referring now to FIG. 2, a second embodiment of the rotor is illustrated at 30. The rotor 30 is similar to the rotor 10 with identical features or components referred to using the same reference numerals as the rotor 10 shown in FIG. 1. The rotor 30, however has a friction section 32 including pair of braking plates, including an inboard braking plate 33a and an outboard braking plate 33b, disposed in a mutually parallel, spaced apart relationship. Friction surfaces, including an inboard friction surface 34a and an outboard friction surface 34b, are disposed on the outwardly facing surfaces of the braking plates 33a and 33b respectively.

Fins 35 connect the braking plates 33a and 33b together thereby defining vents 36 between the braking plates for providing cooling airflow between the braking plates as the rotor turns. The rotor 30 is known as a ventilated rotor. Optional axially extending vents (not shown) may extend through the friction section 22 or 32 for cooling.

The rotors in FIGS. 1 and 2 are shown for illustrative purposes and should not be considered limiting as the invention described herein can be applied to any known rotor formed of any suitable conductive material.

Examples of suitable materials include but are not limited to hypereutectic iron, also known as damped iron, having a carbon equivalent (hereinafter C.E.) of greater than 4.3%. The rotors have a minimum tensile strength of 21,750 psi, 150 Mpa. The damped iron composition includes:

| | |
|---|---|
| C.E. | 4.3-4.6 |
| Carbon | 3.7-3.90 |
| Silicon | 1.9-2.3 |
| Manganese | 1.7 × S + 0.3 min to 0.8% |
| Sulfur | 0.07-0.15 |
| Phosphorus | 0.03 to 0.09% |
| Nickel | 0.10% max |
| Chromium | 0.04-0.25% |
| Molybdenum | 0.08% max |
| Copper | 0.04-0.25% |

and trace amounts of aluminum, titanium, tin, lead and antimony. However, this damped iron composition should not be considered as limiting and any suitable damped iron composition may be used. Alternatively, the rotors may be formed of any suitable gray iron, such as cast iron having a C.E. between 3.7 and 4.3%.

The rotors 10 and 30 are preferably formed by casting damped iron, gray iron, or cast iron in a conventional manner to produce a rotor casting having physical dimensions which are close to the desired final dimensions. The friction surfaces 24a, 24b are then machined using Electric Discharge Machining (EDM), also referred to as Electric Discharge Grinding (EDG) to the desired dimensions. An example of an EDG machining method and apparatus for machining surfaces, such as the friction surface, of gray iron rotors is disclosed in U.S. patent application Ser. No. 09/193,063 which is hereby incorporated herein by reference.

The EDG machined rotors are machined using an EDG apparatus including one or more electrodes connected to one or more power supplies. The rotor is mounted to the EDG apparatus thereby providing an electrical path from the rotor to ground. The surface of the rotor being machined, such as the friction surfaces 24a, 24b, 34a, 34b, is brought near the electrode until the gap therebetween breaks down and an electrical discharge or spark extends between the electrode and the friction surface.

The spark creates a high temperature of approximately 10,000 to 12,000 degrees Celsius at the friction surface. The high temperature vaporizes a portion of the metal of the friction surface. A series of sparks directed at different locations vaporize portions of the friction surface until the entire friction surface is machined to the desired dimensions. Other rotor surfaces may also be EDG machined.

Portions of the EDG machined rotor may additionally be conventionally machined before or after EDG machining. For example, the friction surfaces 24a, 24b may be subjected to a rough machining step using conventional machining prior to EDG machining. Additionally, other portions of the rotor apart from the friction section may be conventionally machined.

It has been found that EDG machined rotors 10 and 30 exhibit significantly improved damping characteristics over rotors of the same size and shape which were not EDG machined but machined using conventional machining techniques. The damping characteristics of a rotor can be characterized by the decay rate D of the rotor, which indicates how the intensity or amplitude of the sound energy emitted by an excited rotor attenuates over time. The decay rate D is measured in dB/second.

It is desirable for a rotor to have a high decay rate so that when the rotor is excited by a stimulus, such as a brake pad, the amplitude of the rotor's vibrations attenuate quickly. A rotor having a high decay rate is considered damped. A damped rotor will be less likely to exhibit “squeal” and other undesirable noise and vibrations during braking.

It has been found that EDG machining the friction surfaces increases the decay rate D as compared to rotors which were not machined or those which were conventionally machined using physical contact with a tool but not EDG machined. Tests were made comparing the decay rate of rotors having friction surfaces 24a, 24b, 34a, 34b machined by conventional machining techniques and rotors having friction surfaces machined by EDG. Both solid rotors and ventilated rotors were tested. For consistency in comparison, the rotors which were EDG machined had the same shape, and were cast using the same casting methods and from gray iron having the same composition as the comparable conventionally machined rotors.

Each rotor was measured for decay rate and resonant frequency at 14 different positions spaced circumferentially around the friction surface between 0 and 63 degrees. The test results indicate that the ventilated EDG machined rotors had decay rates of 192.76 dB/sec and 140.55 dB/sec as compared to the conventionally machined rotor decay rates of 44.04 dB/sec and 34.21 d/sec. The decay rates of the EDG machined rotors were increased between 320 and 560 percent over the conventionally machined rotors.

It has been found that EDG machining a brake rotor formed of damped iron, cast iron or gray iron increases the length, thickness and density of the graphite flakes found in the microstructure of the rotors. To compare the results of EDG machining of brake rotors relative to conventionally machined rotors, optical micrographs, (ie. photographs of enlarged portions) were taken of the microstructure of the metal in both the EDG machined and the conventionally machined ventilated rotors. The friction surfaces of one of the rotors were conventionally machined, and the friction surfaces of the other rotor were EDG machined. For consistency, the same gray iron composition was used to form both rotors.

The micrographs were taken at similar locations on both rotors, near the radially inner edge of the inboard friction plate 33a. The micrographs were then visually inspected and compared according to methods outlined in ASTM specification A247-98 Standard Test Method for Evaluating the Microstructure of Graphite in Iron Castings which is incorporated herein by reference.

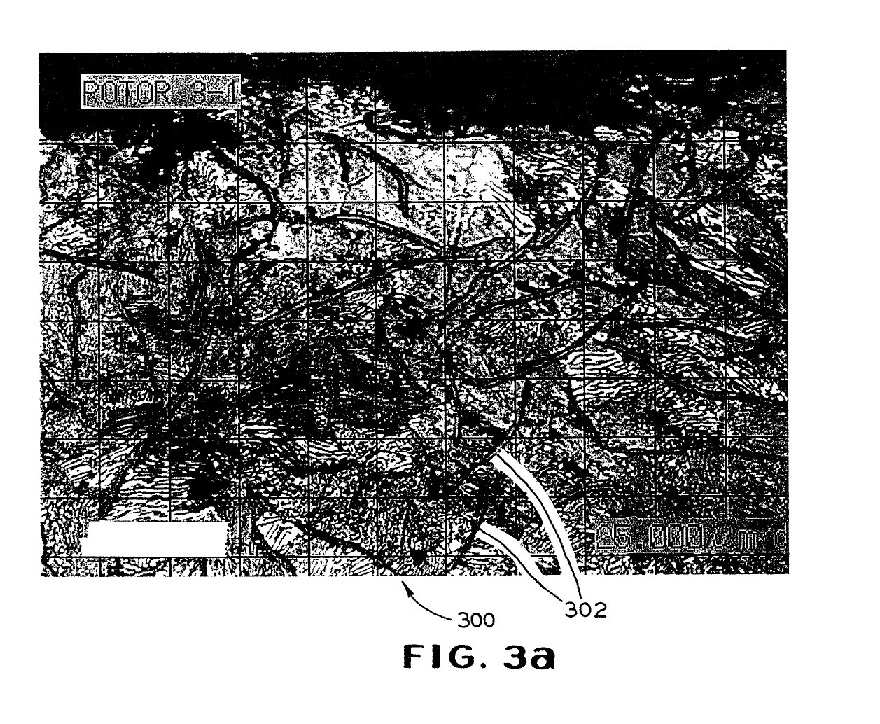

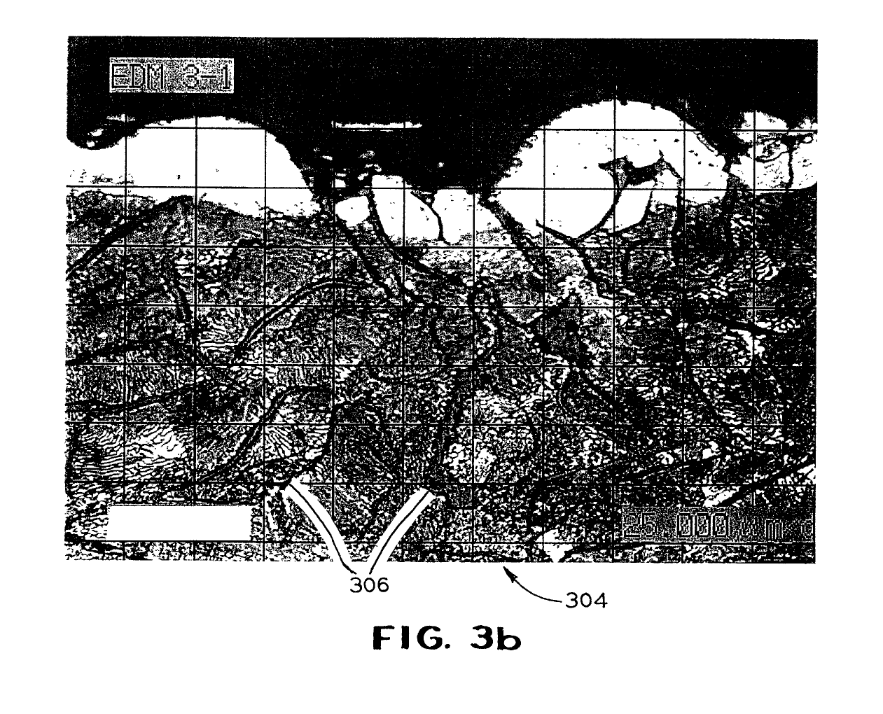

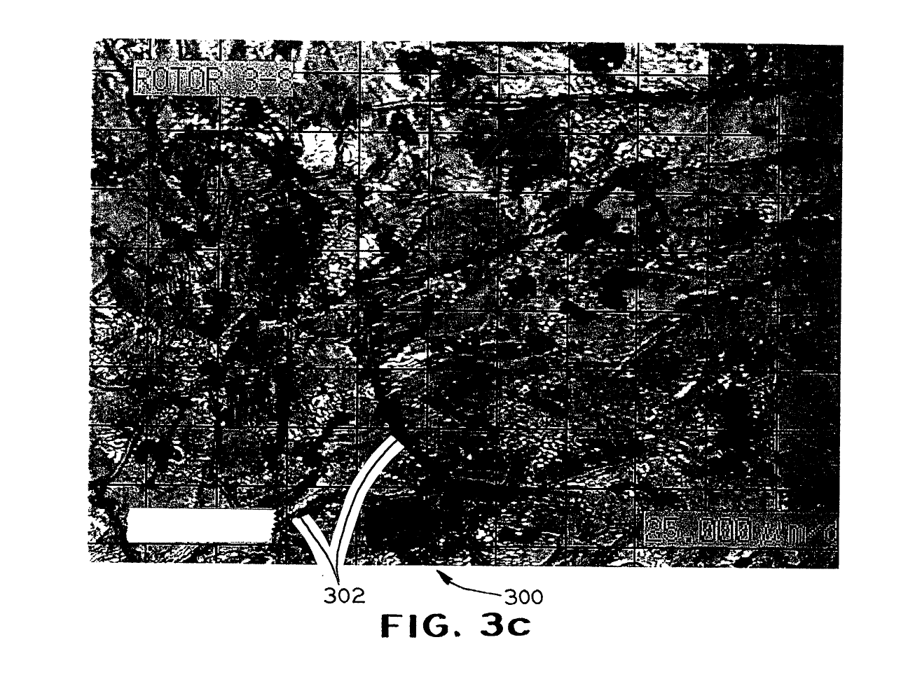

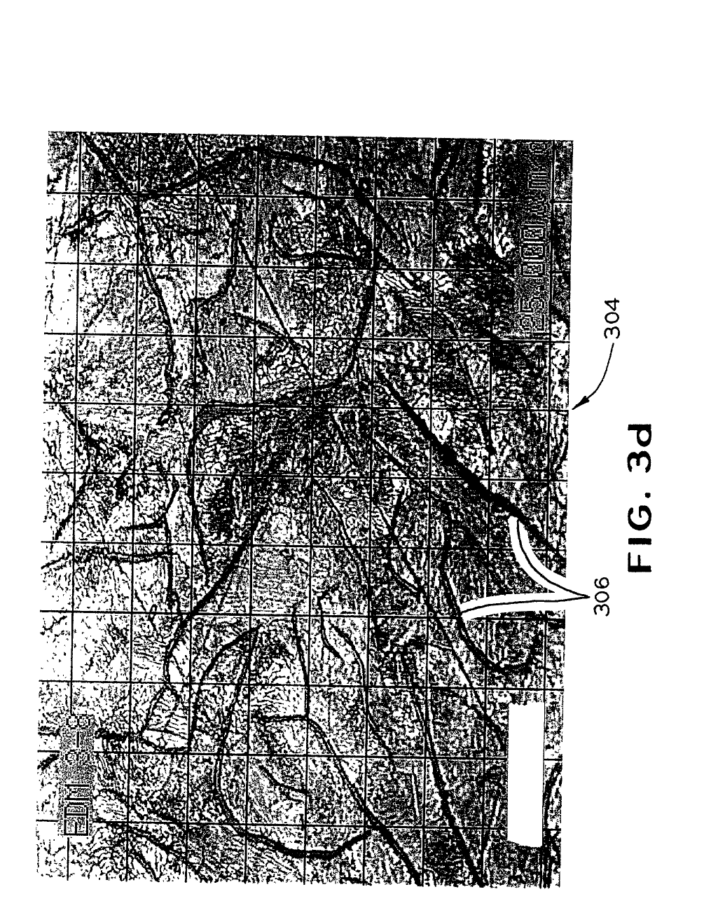

FIG. 3a is a micrograph illustrating the microstructure, shown generally at 300, of the gray iron ventilated rotor having conventionally machined friction surfaces as described above. The microstructure 300 includes a matrix of pearlite with graphite flakes 302 dispersed throughout. The micrograph shown in 3a extends from the inboard friction surface 34a, shown at the top of the figures to a depth of approximately 200 microns into the friction surface.

FIG. 3b is a micrograph illustrating the microstructure, shown generally at 304, of a similar gray iron ventilated rotor which has EDG machined friction surfaces. The EDG machined rotor microstructure 304 includes graphite flakes 306 which are generally longer and thicker than the graphite flakes 302 of the conventionally machined rotor shown above. Furthermore, EDG machined rotor microstructure 304 includes a higher density of graphite flakes 306, ie. more graphite flakes per unit area/volume, than the microstructure of the conventionally machined rotor 302 shown above.

FIGS. 3c and 3d respectively illustrate micrographs of the microstructure of the same conventionally machined and EDG machined rotors at a depth of approximately 1 mm into the friction surface 34a. Again, the EDG machined rotor microstructure 304 of FIG. 3d includes graphite flakes 306 which are generally longer and thicker than the graphite flakes 302 of the conventionally machined rotor shown in FIG. 3c. Furthermore, the EDG machined rotor microstructure 304 at a depth of 1 mm includes a higher density of graphite flakes 306 than the microstructure of the conventionally machined rotor 302 taken at a similar location.

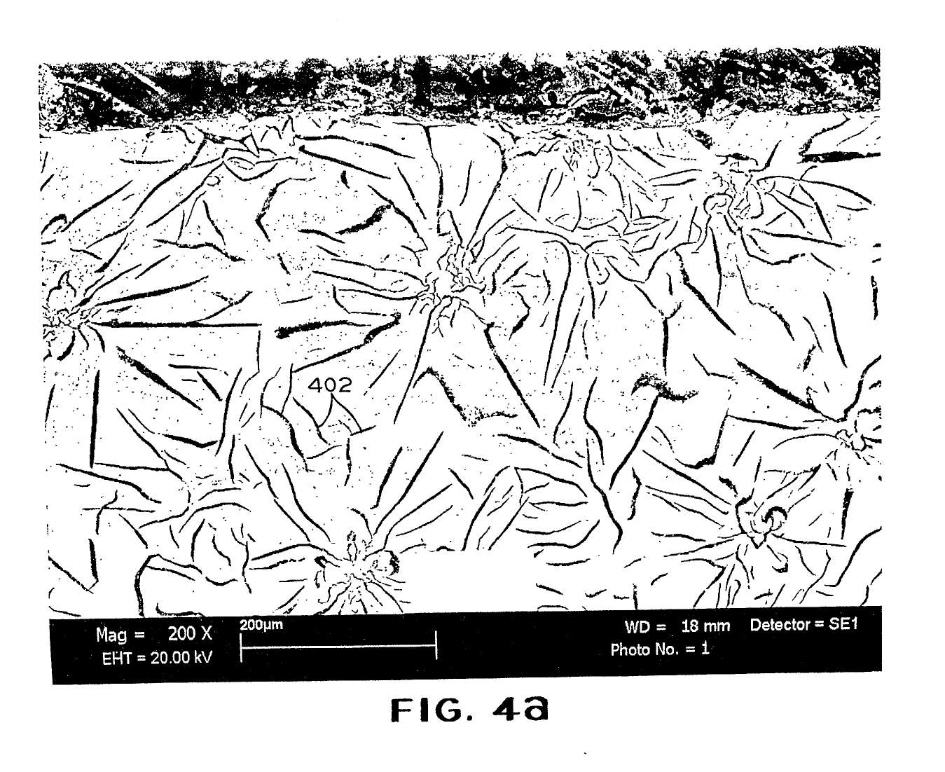

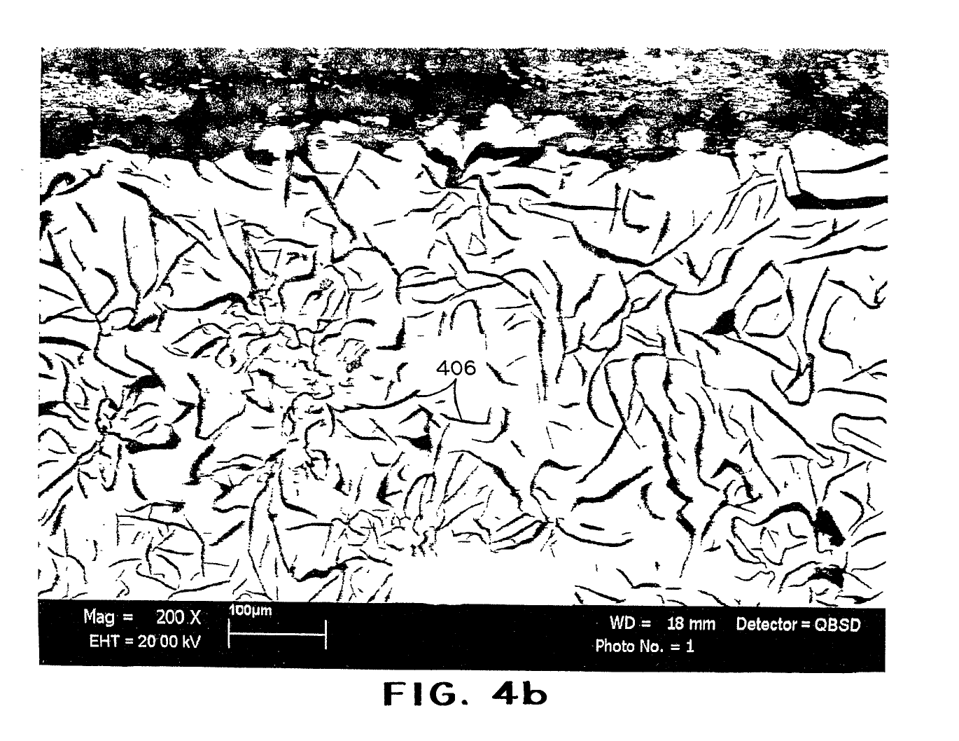

Referring now to FIGS. 4-6, scanning electron micrographs were also taken of conventionally machined rotors and EDG machined rotors to compare the changes in the microstructure of the rotors. The scanning electron micrographs were taken along the radially outer edge of the inboard braking plate 33a. FIG. 4a shows the microstructure illustrating the graphite flakes 402 of the conventionally machined ventilated rotor 30 and extends from the friction surface 34a to a depth of approximately 500 microns. FIG. 4b shows the microstructure illustrating the graphite flakes 406 of the EDG machined rotor 34a of the same location as FIG. 4a.

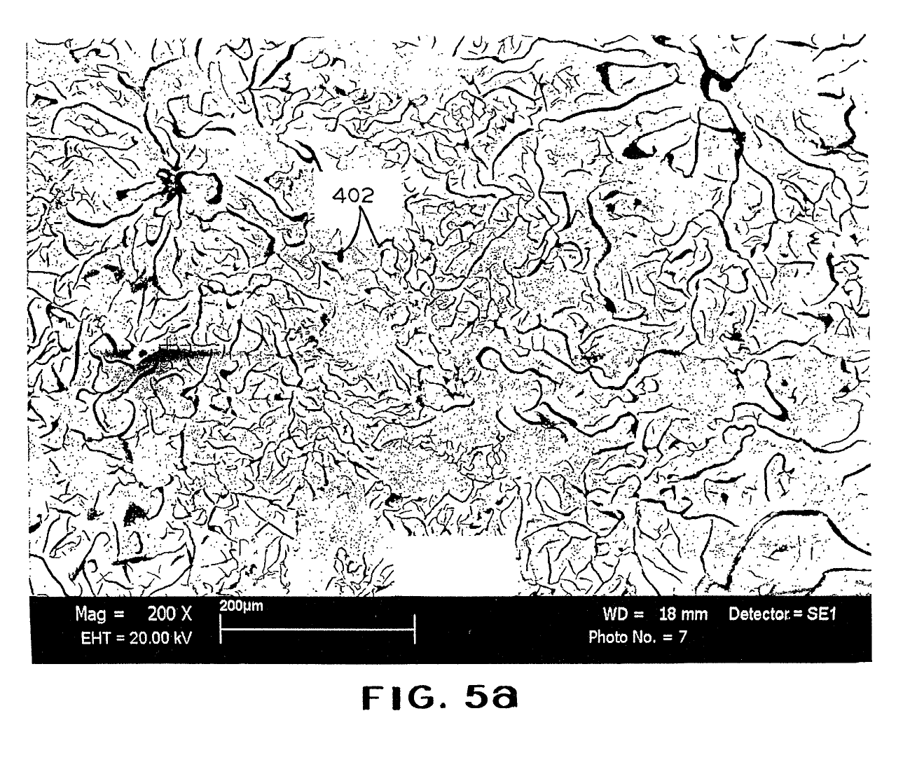

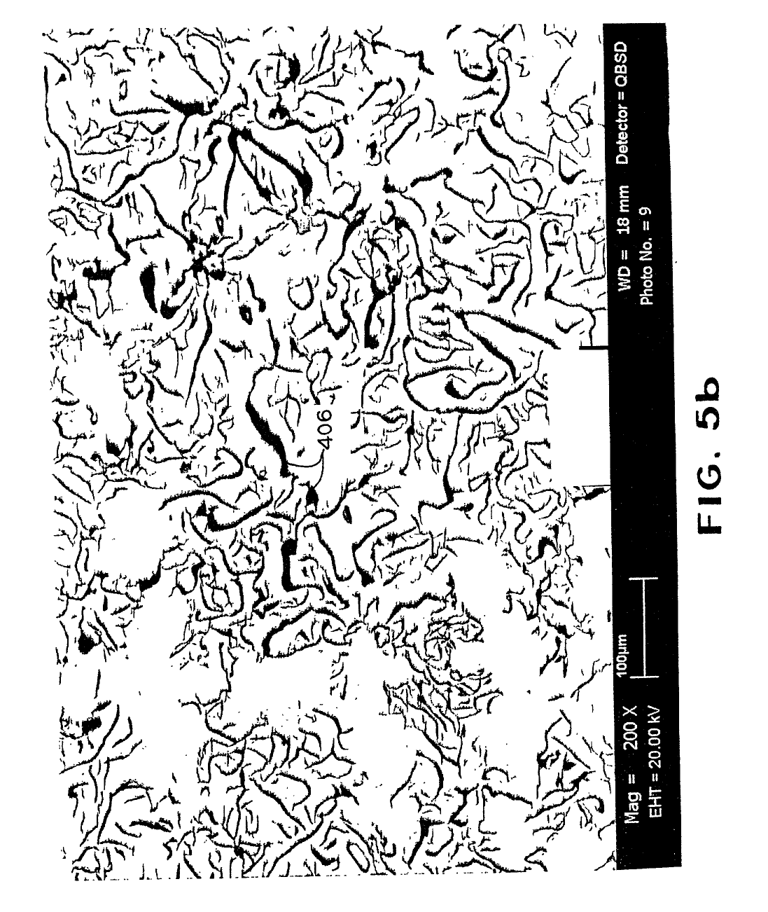

FIG. 5a shows the microstructure illustrating the graphite flakes 402 of the conventionally machined ventilated rotor taken at approximately midway between the machined friction surface 34a and the inner surface which faces the outboard braking plate 33b. FIG. 5b shows the microstructure illustrating the graphite flakes 406 of the EDG machined rotor of the same location as FIG. 5a.

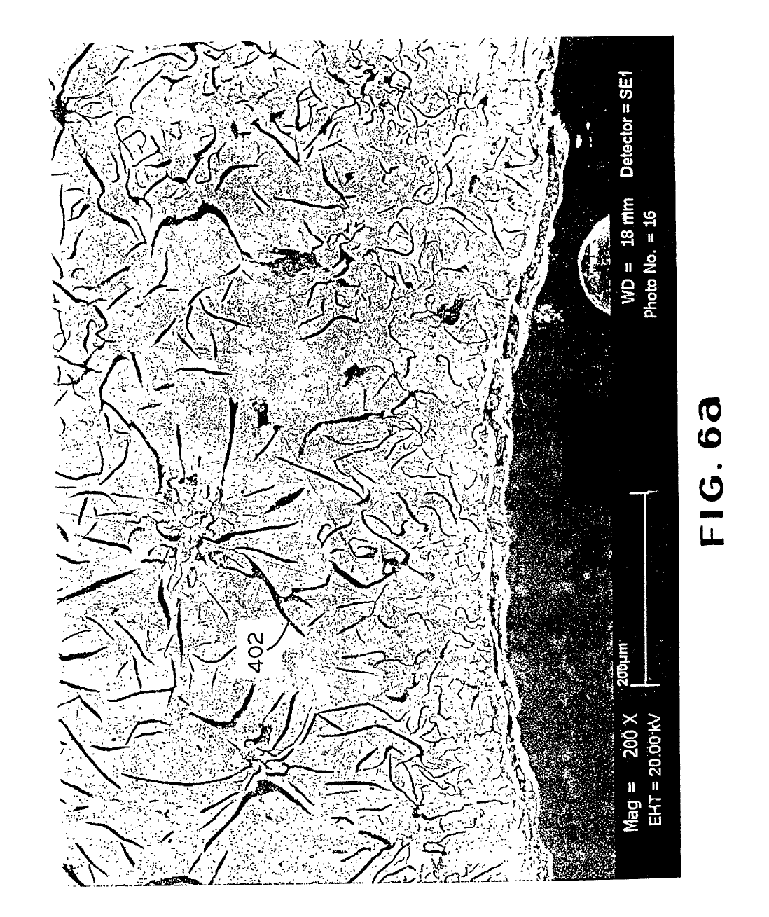

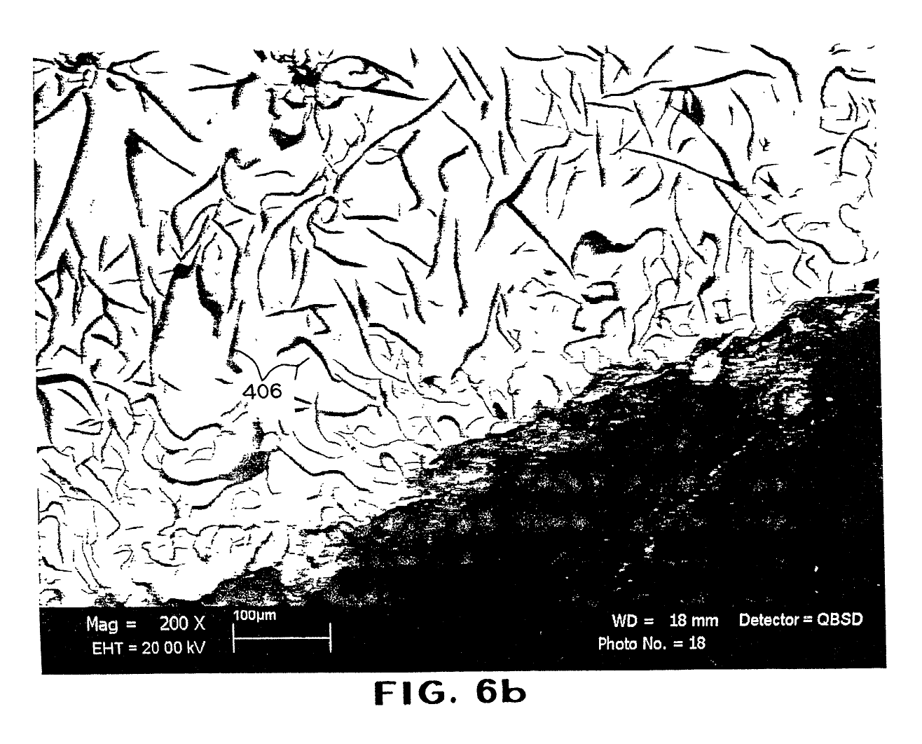

FIG. 6a shows the microstructure illustrating the graphite flakes 402 of the conventionally machined rotor taken at the inner surface of the inboard braking plate 33a which faces the outboard braking plate 33b. FIG. 6b shows the microstructure illustrating the graphite flakes 406 of the EDG machined rotor of the same location as FIG. 6a.

The scanning electron micrographs clearly show that the graphite flakes 406 of the EDG machined rotor are longer, and thicker than the graphite flakes 402 of the conventionally machined rotor. Further, the EDG machined rotor microstructure of FIGS. 4b, 5b, and 6b includes a higher density of graphite flakes 406 than the microstructure of the conventionally machined rotor 402 shown in FIGS. 4a, 5a, and 6a. The increased density of graphite flakes 406 includes more graphite flakes per unit area/volume.

In an effort to eliminate any process variables which may exist even between rotors of the same batch, another test was performed taking optical micrographs of the same rotor both before and after the friction surfaces were EDG machined. The rotor was first mounted in a bridgeport, and a flat was milled to expose a cross-section of the braking plate. Approximately 12 mm of material was removed using a standard carbide-tipped cutter. Next, the machine lines were removed using a conventional table surface grinder having 60-grit sandpaper. Finally, the milled surface was then polished in several steps using a series of finer and finer abrasives in a conventional manner.

The rotor was then supported over a microscope and a series of optical micrographs were taken of the polished surface between the friction surface and a depth of approximately 0.90 mm. A stage micrometer was used to accurately determine the position for each micrograph, with each micrograph covering a distance of approximately 0.18 mm.

After the first series of micrographs were taken, the friction surfaces of the rotor were EDG machined in a manner described above. The flat was then repolished using the same procedure described above. Finally, the EDG machined rotor was again supported over the microscope and a second series of micrographs were taken at the same locations as described. The micrographs were then visually inspected and compared according to the ASTM specification A247-98 described above.

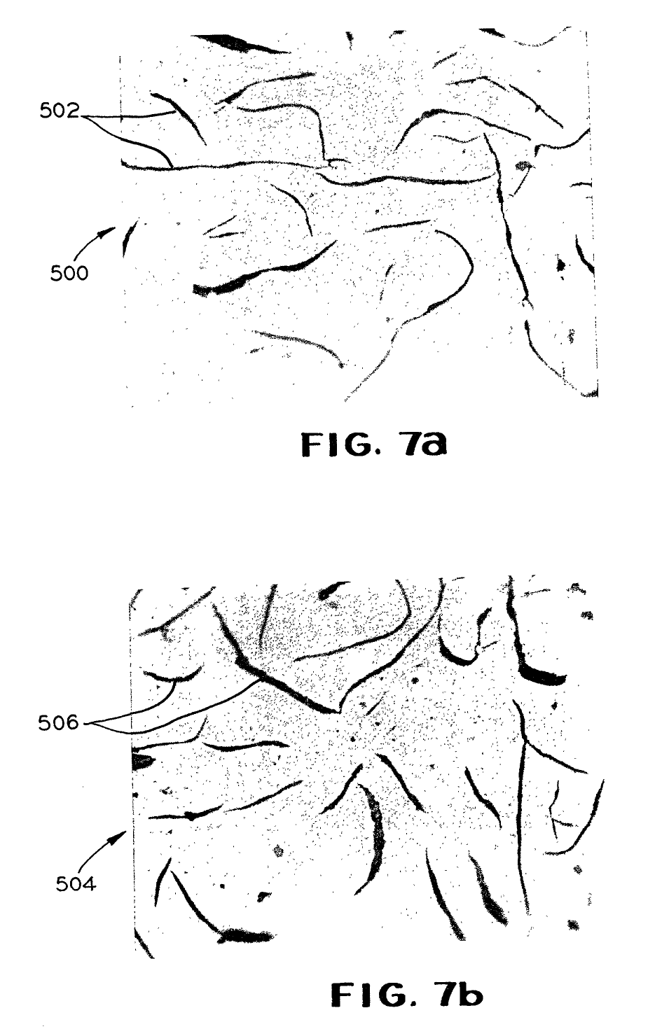

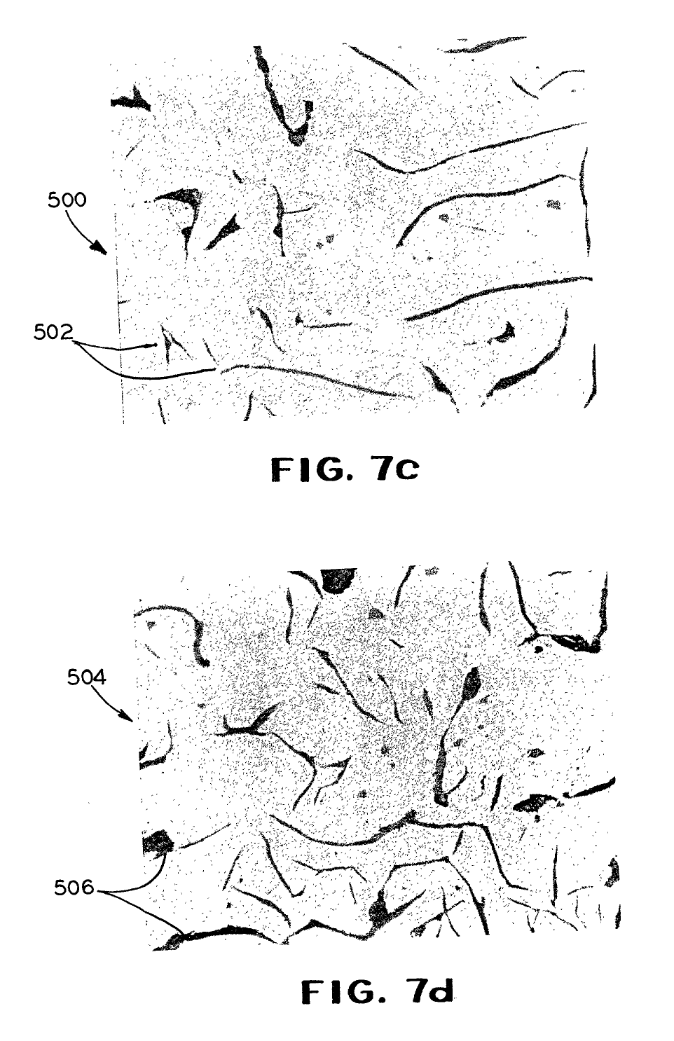

First, a solid rotor 10 formed of a conventional gray iron was tested. The friction surfaces 24a, 24b of the rotor 10 were conventionally machined in a manner described above. Referring to FIG. 7a, a micrograph is shown illustrating the microstructure, shown generally at 500, of the polished section of the conventionally machined solid rotor taken near the friction surface 24a. The microstructure 500 includes a matrix of pearlite with graphite flakes 502 dispersed throughout. FIG. 7b illustrates the microstructure, shown generally at 504, of the solid rotor 24 taken at a similar location after the rotor friction surfaces 24a, 24b were EDG machined as described above. The microstructure 504 also includes a matrix of pearlite with graphite flakes 506 dispersed throughout. The EDG machined rotor microstructure 504 of FIG. 7b includes graphite flakes 506 which are generally longer and thicker than the graphite flakes 502 of the conventionally machined rotor shown in FIG. 7a having friction surfaces which were conventionally machined but not EDG machined. Furthermore, the microstructure 504 of the rotor after it was EDG machined includes a higher density of graphite flakes 506 at the same location than the microstructure of the rotor 502 before it was EDG machined.

Referring to FIG. 7c the microstructure 500 of the solid rotor 10 before it was EDG machined is shown at a depth of approximately 0.90 mm. The microstructure 500 again includes a matrix of pearlite with graphite flakes 502 dispersed throughout. FIG. 7d illustrates the microstructure 504, including the graphite flakes 506, of the solid rotor after it was EDG machined. The micrograph of FIG. 7d was taken at the same depth and location as the micrograph of FIG. 7c. Again, microstructure 504 of FIG. 7d includes graphite flakes 506 which are generally longer and thicker than the graphite flakes 502 of rotor in FIG. 7c which was not EDG machined. The EDG machined rotor microstructure 504 also includes a higher density of graphite flakes 506 than the microstructure of the rotor 502 before it was EDG machined.

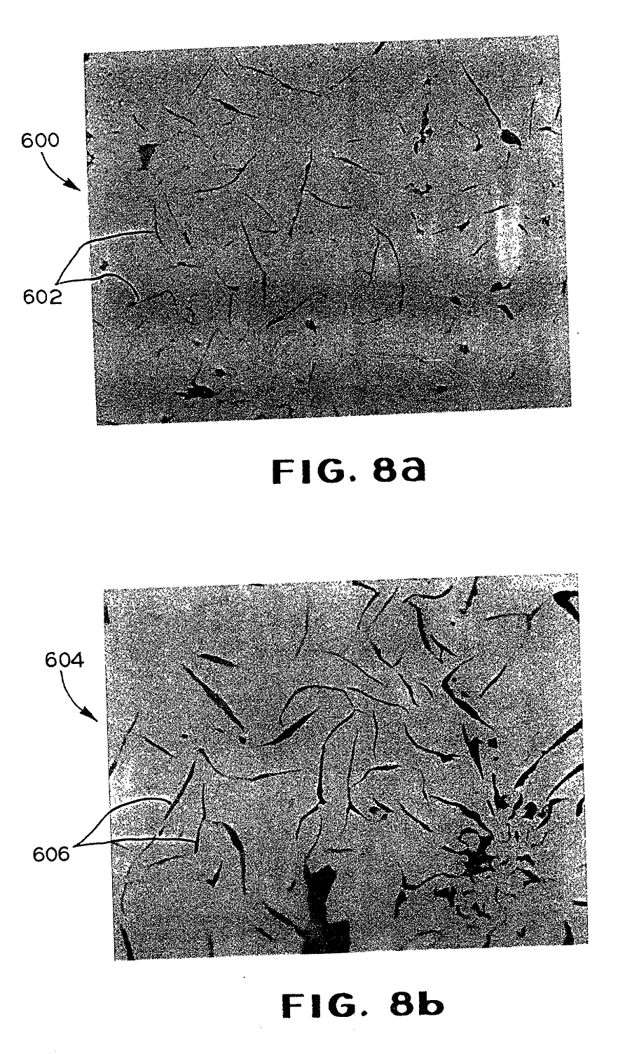

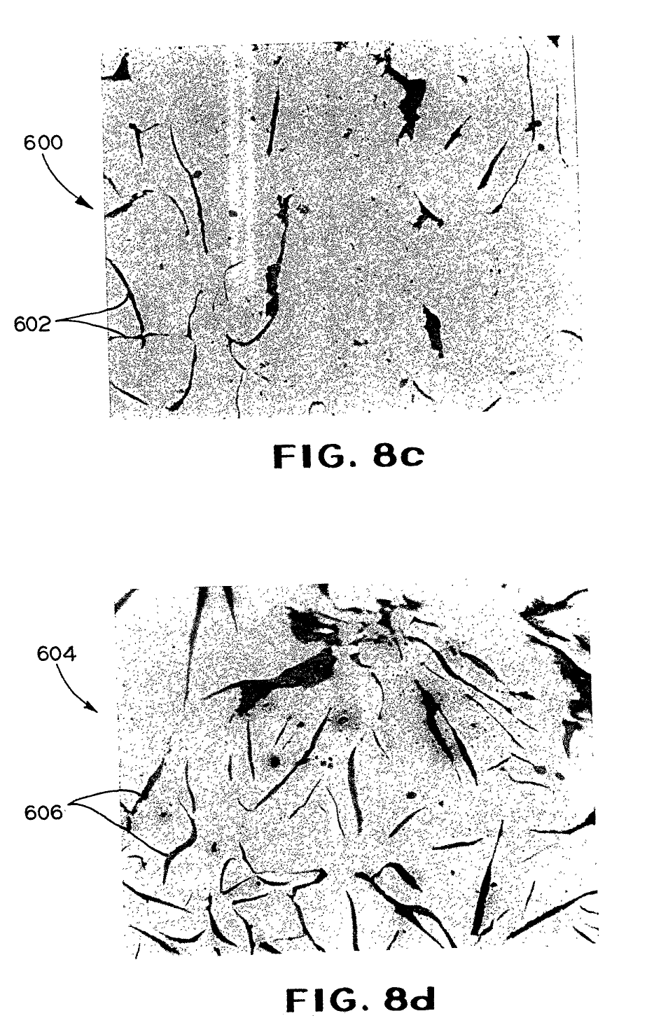

A ventilated rotor 30 was tested in a similar manner, however, the friction surfaces 34a, 34b were left in the as-cast condition rather than being conventionally machined before the first series of micrographs were taken. FIGS. 8a and 8c illustrate the microstructure 600 with graphite flakes 602 at the friction surface and a depth of approximately 0.90 mm respectively for the as-cast rotor. FIGS. 8b and 8d illustrate the microstructure 604 with graphite flakes 606 at the friction surface and a depth of approximately 0.90 mm, respectively, for the as-cast rotor after the friction surfaces were EDG machined. Similar increases in the lengthening, thickening and densification of the graphite flakes 606 of the EDG machined rotor are clearly shown.

Similar results were found for rotors formed of gray iron, damped iron or cast iron.

The graphite is more electrically conductive than the surrounding structure of the gray iron matrix, and it provides electrical paths which carry the electrical energy imparted by the sparks during EDG machining from the surface to the interior of the rotor and to portions of the rotor some distance from the EDG machined surface.

The electrical energy heats the metal matrix containing the graphite to high temperatures of over 3000° F. After the spark is gone, the metal matrix quickly cools to an amorphous state. The heating and rapid cooling of the graphite causes the graphite to lengthen and thicken. The metal matrix having longer and thicker graphite flakes results in a material having an increased rate of decay resulting in improved damping.

In accordance with the provisions of the patent statutes, the principles and mode of operation of this invention have been described and illustrated in its preferred embodiment. However, it must be understood that the invention may be practiced otherwise than specifically explained and illustrated without departing from its spirit or scope.

We claim:

1. A method of increasing the average lengths of graphite in a brake rotor including:
providing a brake rotor; and
machining a surface of the rotor using EDG machining.

2. The invention defined in claim 1 wherein said brake rotor is formed of gray iron.

3. The invention defined in claim 1 wherein said brake rotor is formed of damped iron.

4. The invention defined in claim 1 wherein said brake rotor is formed of cast iron.

5. A method of increasing the average thicknesses of graphite in a brake rotor including:
providing a brake rotor; and
machining a surface of the rotor using EDG machining.

6. The invention defined in claim 5 wherein said brake rotor is formed of gray iron.

7. The invention defined in claim 5 wherein said brake rotor is formed of damped iron.

8. The invention defined in claim 5 wherein said brake rotor is formed of cast iron.

9. A method of increasing the average density of graphite per unit area/volume of a brake rotor including:
providing a brake rotor; and
machining a surface of the rotor using EDG machining.

10. The invention defined in claim 9 wherein said brake rotor is formed of gray iron.

11. The invention defined in claim 9 wherein said brake rotor is formed of damped iron.

12. The invention defined in claim 9 wherein said brake rotor is formed of cast iron.
